(19) United States
(12) Patent Application Publication
(10) Pub. No.: US 2010/0241756 A1
(43) Pub. Date: Sep. 23, 2010

(54) METHOD OF AUTHENTICATION CONTROL OF ACCESS NETWORK IN HANDOVER OF MOBILE NODE, AND SYSTEM THEREOF

(75) Inventors: Hyun-woo Lee, Daejeon-si (KR); Kwi-hoon Kim, Daejeon-si (KR); Won Ryu, Daejeon-si (KR); Byung-sun Lee, Daejeon-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunication Research Institute, Daejeon-si (KR)

(21) Appl. No.: 12/528,519

(22) PCT Filed: Jul. 7, 2008
(86) PCT No.: PCT/KR2008/003987

§ 371 Date: Aug. 25, 2009

(30) Foreign Application Priority Data
Dec. 6, 2007 (KR) 10-2007-0126356

(51) Int. Cl. G06F 15/16; G06F 21/00

(52) U.S. Cl. 709/229; 726/3

(57) ABSTRACT

Provided are a method and a system for controlling access authentication in the process of a handover. The method of controlling access authentication in the process of handover of a mobile node in a network that consists of a core network and a plurality of access networks, the method comprising: when the mobile node initially accesses a first access network, performing access authentication of the mobile node and registering and managing the authentication information by using a user profile server, and searching for a host channel adaptor adjacent to the mobile node and transmitting identification, a profile, and authentication information of the mobile node to a network access server, in which the searched host channel adaptor is mounted, by using a mobility control server; when the mobile node moves to a second access network, performing a handover procedure and performing re-access authentication procedure by transferring authentication information regarding the handover to a network access server which is included in the second access network; and after performing the re-access authentication procedure, searching for a host channel adaptor adjacent to the mobile node and transmitting authentication information to a network access server which includes the searched host channel adaptor by using the mobility control server. Accordingly, an access delay time in the process of a handover can be reduced.

### TECHNICAL FIELD

The present invention relates to a handover of a mobile node, and more particularly, to a method and a system for controlling authentication of access to an access network in the process of handover.

This work was partly supported by the IT R&D program of Ministry of Information and Communication (MIC)/Institute for Information Technology Advancement (IITA) [2006-S-058-02, Integrated Network Service Control technology based on AII-IP]

### BACKGROUND ART

In the process of handover of a mobile node in a homogeneous network or a heterogeneous network of an Internet protocol (IP)-based wireless communication access network, access authentication needs to be performed for each access network.

In other words, a mobile node needs to be authenticated for access to a first access network, and needs to be separately authenticated for access to a second access network when the mobile node is handed over to the second access network.

In the conventional authentication for an access network, since an access authentication procedure for a first access network and a re-access authentication procedure for a second access network due to a handover of the mobile node are not separately performed, a substantial amount of time is consumed in the re-access authentication procedure, causing handover delay.

### TECHNICAL PROBLEM

The present invention provides a method and a system of controlling access authentication which can simplify procedures for access authentication for a new access network when a mobile node is handed over to the new access network and thus can reduce delay in handover procedures and provide a seamless service to a user.

### TECHNICAL SOLUTION

The present invention discloses a method of controlling access authentication in the process of handover of a mobile node in a network that consists of a core network and a plurality of access networks, the method comprising: when the mobile node initially accesses a first access network, performing access authentication of the mobile node and registering and managing the authentication information by using a user profile server, and searching for a host channel adaptor adjacent to the mobile node and transmitting identification, a profile, and authentication information of the mobile node to a network access server, in which the searched host channel adaptor is mounted, by using a mobility control server; when the mobile node moves to a second access network, performing a handover procedure and performing re-access authentication procedure by transferring authentication information regarding the handover to a network access server which is included in the second access network; and after performing the re-access authentication procedure, searching for a host channel adaptor adjacent to the mobile node and transmitting authentication information to a network access server which includes the searched host channel adaptor by using the mobility control server.

The mobility control server and the user profile server may use user-data-request (UDR) and user-data-answer (UDA) messages, or profile-update-request and profile-update-answer messages in order to transfer and update mobility control related profile information of the mobile node. The present invention also discloses a system for controlling access network authentication in the process of a handover, the system comprising: a user profile server which performs access authentication of a mobile node when the mobile node initially accesses a first access network; a mobility control server which searches for a host channel adaptor adjacent to the mobile node and transmits ID, profile and authentication information of the mobile node to a network access server which includes the searched host channel adaptor; and a network access server which performs a handover of the mobile node when the mobile node moves to a second access network, receives authentication information of the mobile node, and performs re-access authentication, wherein the mobile control server searches for a host channel adaptor adjacent to the mobile node and transmits the authentication information to a network access server which includes the searched host channel adaptor after the re-access authentication is performed.

Additional features of the invention will be set forth in the description which follows, and in part will be apparent from the description, or may be learned by practice of the invention.

### ADVANTAGEOUS EFFECTS

According to the present invention, access authentication for a new access network in a homogeneous network or in a heterogeneous network is performed directly by a network access server, and thus re-access authentication delay can be minimized.

Consequently, first, with respect to mobility control, various information of a mobile node is provided to a mobility control server, and thus effective handover control between handover control agents can be achieved.

Second, a seamless multimedia service which requires a real-time response can be provided by minimizing re-access authentication delay.

Third, a message structure of data which are transmitted and received between a user profile server and a mobility control server is clearly defined, so that a profile of a user involved with access can be accurately managed in real time.

Fourth, in view of mobility control, effective mobility control can be achieved through a media independent handover (MIH) by providing various features of a mobile node.

Fifth, a definite access termination of a mobile node is notified to a mobility control server, and this notification is transmitted to a handover control agent, so that status information of a mobile node which is managed through the use of a timer and a relevant table are initialized and effective resource management can be performed.

Finally, an access-based user profile information, which is managed in a user profile server in association with a network access server and a mobility server in real time from the time of the initial access to an access network, is provided to a location information-based application server or a variety of media providing servers, and hence this user profile information can be utilized as status information for various customized services.

### DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a network configuration view for explaining procedures of high-speed handover access authentication control according to an embodiment of the present invention.

FIG. 2 is a view for explaining initial procedures in the process of high-speed handover access authentication according to an embodiment of the present invention.

FIG. 3 is a view for explaining procedures of controlling a high-speed handover access authentication according to an embodiment of the present invention.

FIG. 4 is a view for explaining procedures of managing authentication information and profile information between a user profile server and a mobility information control server according to an embodiment of the present invention.

### MODE FOR INVENTION

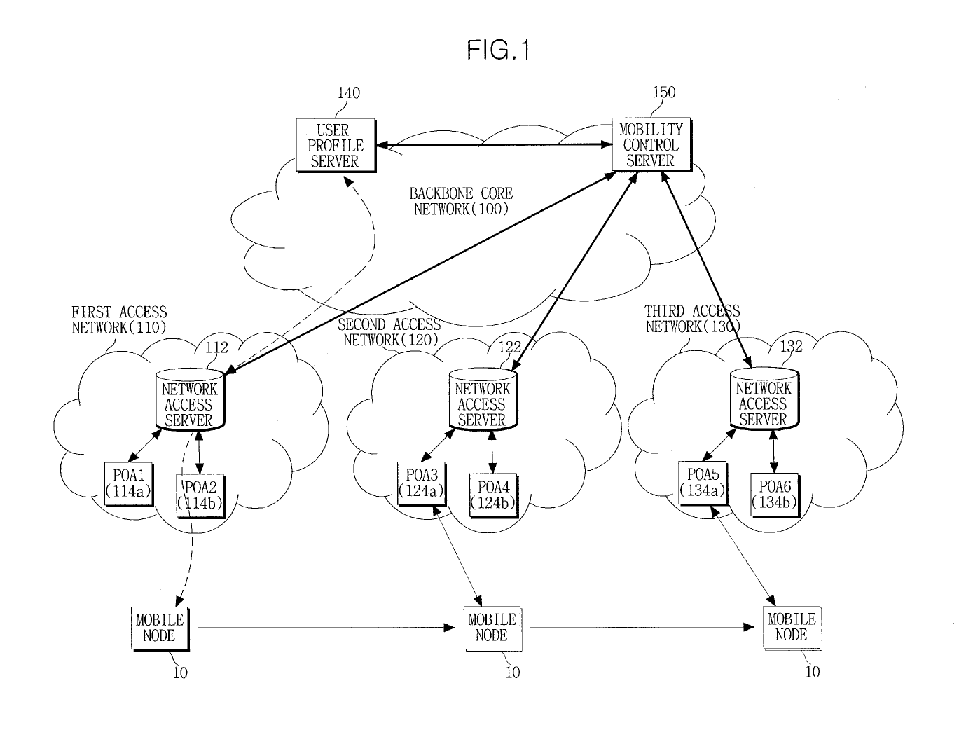

FIG. 1 is a network configuration view for explaining procedures of high-speed handover access authentication control according to an embodiment of the present invention.

Referring to FIG. 1, a mobile communication network consists of a backbone core network 100 and a plurality of access networks 110, 120, and 130. The backbone core network 100 includes a user profile server (UPS) 140 and a mobility control server (MCS) 150.

The user profile server 140 performs an authentication authorization account (AAA) for each access network 110, 120, and 130, and manages a user access status and a mobility profile.

The mobility control server 150 performs location registration of a mobile node 10 at an IP address, and mobility control and management.

Each of the access networks 110, 120, and 130 has a network access server (NAS) 112, 122, and 132 which allocates an IP address to the mobile node 10 when the mobile node 10 initially accesses to each network 110, 120, and 130 and acts as an agent for location registration in the mobility control server 150 in the process of a handover. Each network access server 112, 122, and 132 includes a host channel adaptor (HCA) function.

Each the network access server 112, 122, and 132 acts as an access router for the mobile node 10, and examples of the network access server 112, 122, and 132 include a gateway general packet radio service (GPRS) support node (GGSN) in a third generation mobile communication network, an access control router (ACR) in a wireless broadband (WiBro), and an access router (AR) in a wireless local area network (LAN). The mobile node 10 sets wireless connection through pairs of points of attachment (POA) 114a, 114b, 124a, 124b, 134a, and 134b, each pair of which are connected to each of the network access servers 112, 122, and 132. Examples of the POA include Node-B in third generation mobile communication network, a radio access station (RAS) in WiBro, and an access point (AP) in a wireless LAN.

A connection between the mobility control server 150 and each network access server 112, 122, and 132 by use of the host channel adaptor (HCA) is formed in the same way as in the a virtual private network (VPN) which is separated from a user data channel, not in a way of an Internet protocol (IP) tunneling method of the conventional mobile Internet protocol (MIP). Therefore, in a best-effort network, a handover control processing message and an authentication information delivery message can be safely and fast transferred with priority. Similarly, an additional channel between the mobility control server 150 and the user profile server 140 can be established in the same manner.

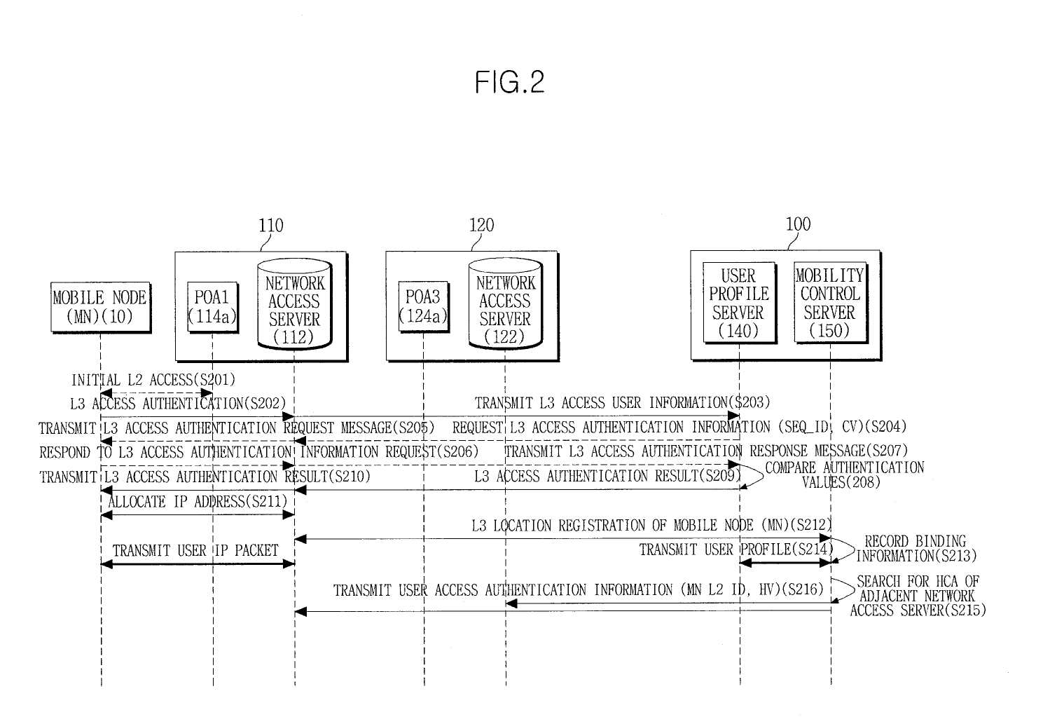

FIG. 2 is a view for explaining initial procedures in the process of high-speed handover access authentication according to an embodiment of the present invention.

When the mobile node 10 is turned on, the mobile node 10 commences the initial access process to attempt to access a core network through an access network adjacent to the mobile node 10. Specifically, the mobile node 10 performs two layer (L2) access to a POA1 114a by L2 link connection procedure according to a kind of a network interface card (NIC) that is mounted on the mobile node 10 (operation S201). The detailed procedures of operation S201 follow the general method of a L2 layer provided by each access network, and the general method is not in the scope of the present invention.

Once the L2 link connection is complete, the mobile node 10 commences access authentication for a L3 layer. Specifically, the conventional authentication function is performed by using a user identification (ID) and a password, the network access server 112 allocates an IP address to the mobile node 10 when the access authentication for the user profile server 140 that manages a user profile succeeds.

More specifically, when the L2 access of the mobile node 10 is complete, user information such as the user ID and the password is transmitted to the network access server 112 according to a predetermined protocol (operation S202), and the network access server 112 transmits the user information for initiating L3 authentication to the user profile server 140 using remote authentication dial-in user service (RADIUS) protocol or diameter protocol (operation S203). Then, the user profile server 140 which includes data values, which are required according to an algorithm used for user authentication of the mobile node 10, in an authentication request message and transmits the authentication request message to the mobile node 10 (operation S204).

The algorithm used for the user authentication may be EAP-MD5, EAP-AKA, EAP-TLS, or USIM.

For instance, if the algorithm is EAP-MD5 which is most used in a public wireless LAN, data including {seq_ID} and a challenge value (CV) is inserted into the authentication request message and transmitted to the mobile node 10 through the network access server 112 (operations S204 and S205).

The mobile node 10 which receives the authentication request message generates authentication information and transmits the generated information to the user profile server 140 (operations S206 and S207), and when the algorithm is EAP-MD5 according to the current embodiment of the present invention, a hash value (HV) of {password, CV, seq_ID} which is obtained by MD5 method is included in an authentication response message, and transmitted to the user profile server 140 through the network access server 112.

The user profile server 140 compares a hash value of user information to the hash value that is generated and transmitted from the mobile node 10 (operation S208), and informs the mobile node 10 of the authentication result according to the comparison result (operations S209 and S210).

When the authentication succeeds, an IP address is allocated to the mobile node 10 to be used for IP packet transmission in a first access network (operation S211). When L3 address is normally allocated to the mobile node 10, L3 location registration on a mobility control server 150 in a backbone core network 100 is performed according to a mobility protocol (such as MIP or PMIP) of the L3 layer (operation S212).

By the above procedure, the mobility control server 150 makes binding information of the mobile node 10 which consists of L2 address and home of address (HoA) of the mobile node 10 and the IP address of the mobility control server 150, and records the binding information in a binding table of the mobile node 10 (operation S213).

The mobility control server 150 is provided with a mobility-related profile of the mobile node 10, which is required for control of handover between heterogeneous networks, from the user profile server 140 (operation S214). The profile of the mobile node 10 includes a kind and a form of an L2 access network interface card (NIC) of the mobile node 10 and a subscribed communication provider of the mobile node 10.

Furthermore, the mobility control server 150 receives the authentication information from the user profile server 140, the authentication information including the hash value (HV) that was used for the initial access authentication procedure. The authentication information is managed along with L2 ID as the binding information, network access servers (network access serveres) with a host channel adaptor (HCA), which are adjacent to the POA to which the mobile node 10 is connected, are searched for (operation S215), and the authentication information (HV) is transmitted to the network access servers with the host channel adaptor (HCA) mounted therein (operation S216).

The operations described above will be explained in detail with reference to the configuration view of the network in FIG. 1 again.

When the mobile node 10 performs the L3 access authentication and L3 location registration in the network access server 112 through the POA2 114a in the first access network 110, the mobility control server 150 receives access authentication information and relevant profile information from the user profile server 140 through a VPN channel.

Then, the mobile node 10 searches a neighbor map for the POA1 114a and the POA3 124a which are adjacent to the POA2 114b to which the mobile node 10 is connected, and transmits the authentication information to the network access servers 112 and 122, each of which includes the HCA that is connected to the mobility control server 150.

The handover between the POA2 114b and the POA1 114a is performed in the same network, that is, the first access network 110, and thus this is a handover in the homogeneous network. However, the second access network in which the POA3 124a is included may be a heterogeneous network. Thus, the L2 ID that is managed by the network access server 122 may be changed.

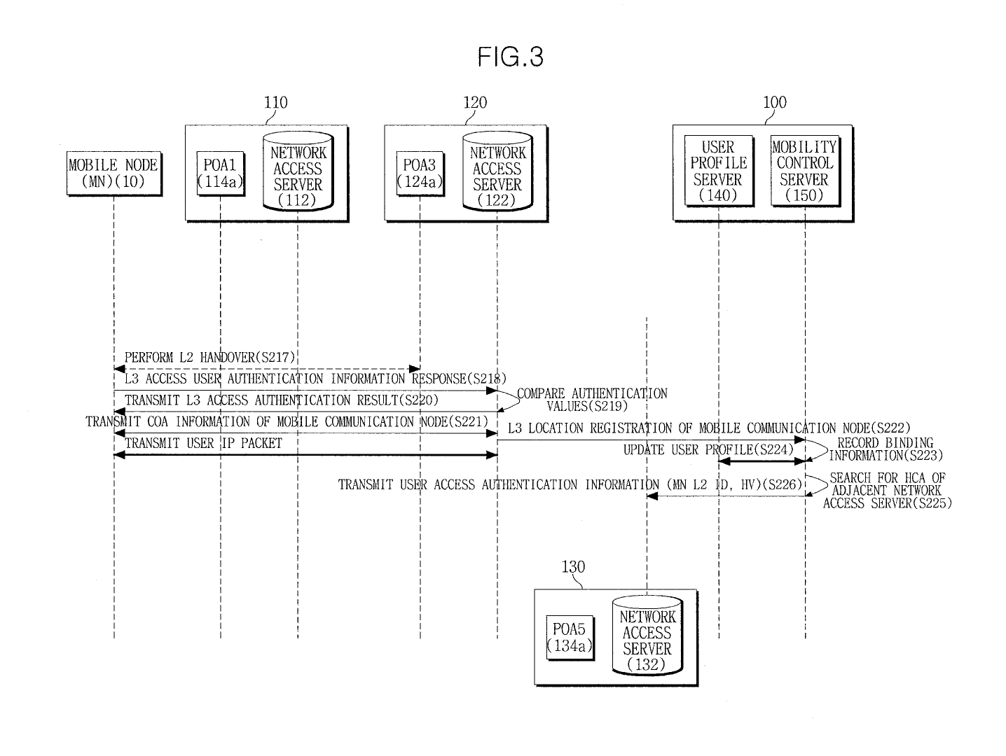

FIG. 3 is a view for explaining procedures of controlling a high-speed handover access authentication according to an embodiment of the present invention.

The procedures of controlling the high-speed handover access authentication when a mobile node 10 moves from a first access network 110, which the mobile node 10 initially accesses, to a second access network 120, which is new, will now be described.

L2 handover is firstly performed in both cases of the handover in a homogeneous network and the handover between heterogeneous networks (operation S217). When L2 link connection is complete in the process of the handover, the mobile node 10 transmits user authentication information (HV), which is used for the initial access, together with L2 ID to a network access server 122 in the new access network 120, thereby performing a L3 re-access authentication procedure (operation S218). The network access server 122 compares pieces of authentication information of individual L2 IDs which are transmitted through the HCA and managed by the network access server 122 (operation S219), and determines whether to permit the access and transmits L3 access authentication result to the mobile node 10 (operation S220).

Care of address (CoA) of the HCA mounted in the network access server 120 is notified according to mobility protocol (MIP or PMIP) of L3 layer which will be used later (operation S221), and L3 location registration is performed in the mobility control server 150 in the core network 100 (operation S222).

The mobility control server 150 records CoA information connected to the L2 address and home of address (HoA) in a binding table of the mobile node 10 as new binding information (operation S223). Furthermore, after the L3 re-access authentication and L3 location registration of the mobile node 10 are complete, a user profile (access PoA address, CoA, etc.) is updated from the mobility control server 150 to the user profile server 140 (operation S225). Network access servers with the HCA, adjacent to the network access server of the POA to which the mobile node 10 is connected, are searched for (operation S225), and the authentication information (HV) is transmitted to the network access server 132 which includes a corresponding HCA (operation S226). At this time, due to the characteristics of heterogeneous mobile communication network, where a plurality of POAs are searched for according to a type of L2 network interface card of the mobile node 10, the authentication information (HV) is transmitted together with corresponding L2 ID to all network access servers that include the corresponding HCA.

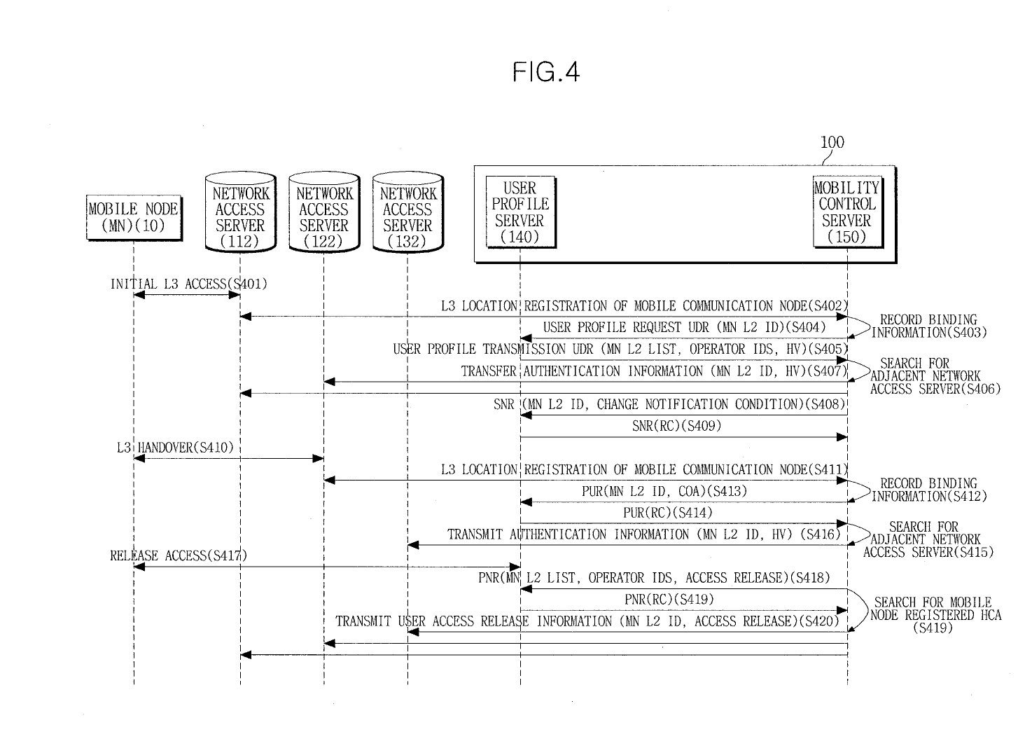

FIG. 4 is a view for explaining procedures of managing authentication information and profile information between a user profile server 140 and a mobility information control server 150 according to an embodiment of the present invention.

Access protocol between the user profile server 140 and the mobility control server 150 uses diameter-based Sh access standards and command message structure. When the initial L3 access procedure of the mobile node 10 is complete as described above with reference to FIGS. 2 and 3 (operation S401), L3 location registration of the mobile node 10 from the network access server 112 in the first access network 110 to the mobility control server 150 is performed (operation S402).

The mobility control server 150 records the binding information of the mobile node 10 (operation S403), and L2 ID of the mobile node 10 is inserted into a user-data-request (UDR) command message and a user profile is requested to the user profile server 140 (operation S404).

Then, the user profile server 140 responds to the user profile request from the mobility control server 150 by adding the authentication information (HV) used for the initial access procedure, together with a type and a form of L2 NIC of the mobile node 10 and subscribed communications provider ID, in a data domain of the UDR command message and sending the message to the mobility control server 150 (operation S405).

A global binding table managed by the mobility control server 150 is searched for adjacent network access servers of the mobile node 10 (operation S406), and the authentication information (HV) is transmitted to the searched network access server (operation S407). In operation S407, a handover control message is used between the mobility control server 150 and the network access server. The HCA of the network access server manages authentication information of each L2 ID in a mobile node binding table for the lifetime of the authentication information.

When the clear access release of the mobile node 10 is made by using a subscribe-notifications-request (SNR) message after the mobility control server 150 distributes the authentication information during the initial access, the mobility control server 150 subscribes to the user profile server 140 so that it can be notified (operation S408), and the mobility control server 150 is informed of the subscription result (operation S409).

The mobile node 10 moves from the first access network 110, which the mobile node 10 initially accesses, to the second access network 120, a high-speed L3 handover access authentication control procedure is completely performed for the network access server 122 (operation S410). Then, L3 location registration is performed from the HCA of the network access server 122 in the new access network to the mobility control server 150 (operation S411).

The mobility control server 150 records the CoA which is mapped with a HoA in binding information of the mobile terminal 10 (operation S412), and transfers data of information regarding the moved mobile node 10, such as a new CoA, to the user profile server 140 (operation S413).

The user profile server 140 updates mobility profile status information to data transferred from the mobility control server 150, and transmits a profile-update answer (PUA) command message to the mobility control server 150 (operation S414). At the same time, the mobility control server 150 re-searches the global binding table, which is managed by the mobility control server 150, for the HCA of the adjacent network access server of the mobile node 10 (operation S415) as in the initial access procedures, and transfers mobile node L2 ID and authentication information (HV) to the corresponding network access server (operation S416). Such the information is used for access authentication process for a network access server in a new access network when the mobile node 10 is high-speed handed over to the adjacent access network.

Conventionally, an additional authentication control procedure is not required for L3 access termination of the mobile node 10, but in the current embodiment of the present invention, when a user carries out definite access release procedures with the mobile node, an access release status is transmitted to the user profile server 140 through the network access server (operation S417). Also, the user profile server 140 informs the mobility control server 150 of the access release, together with the L2 list and subscribed communication provider of the mobile node 10, using a push-notification-request (PNR) command message (operation S418).

The mobility control server 150 searches the global binding table for the mobile node registered HCA, and transfers mobile node access release information to the network access server which includes the corresponding HCA (operation S419), and response to the user profile server 140 by transmitting a push-notification-answer (PNA) (operation S420). Through the access release notification procedure, the status information of the mobile node 10 and the relevant table are deleted from the mobility control server 150 and the HCA.

The method of controlling access authentication according to the present invention can be written as computer programs. Codes and code segments for accomplishing the computer programs can be easily construed by programmers skilled in the art to which the present invention pertains. Also, the programs are stored in a computer readable recording medium, and the method of controlling access authentication according to the present invention is implemented by a computer that reads and executes the programs. Examples of the computer readable recording medium include magnetic storage media, optical recording media, and carrier waves.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

The present invention can be efficiently applied to various technologies that provide IP-based mobility, and more particularly, to an access authentication control technology for a high-speed handover of a mobile node.

1. A method of controlling access authentication in the process of handover of a mobile node in a network that consists of a core network and a plurality of access networks, the method comprising:
when the mobile node initially accesses a first access network, performing access authentication of the mobile node and registering and managing the authentication information by using a user profile server, and searching for a host channel adaptor adjacent to the mobile node and transmitting identification, a profile, and authentication information of the mobile node to a network access server, in which the searched host channel adaptor is mounted, by using a mobility control server;
when the mobile node moves to a second access network, performing a handover procedure and performing re-access authentication procedure by transferring authentication information regarding the handover to a network access server which is included in the second access network; and
after performing the re-access authentication procedure, searching for a host channel adaptor adjacent to the mobile node and transmitting authentication information to a network access server which includes the searched host channel adaptor by using the mobility control server.

2. The method of claim 1, wherein the performing of the handover procedure comprises:
maintaining the authentication information used for an initial access authentication of the mobile node during an L3 access procedure, and performing an L2 handover procedure and transferring L2 ID and authentication information to a network access server which belongs to the second access network when the mobile node moves to the second access network; and
when a handover is in progress, comparing pieces of authentication information for each L2 ID which are transferred through a host channel adaptor and managed by a network access server in the second access network, determining whether to allow access, and transferring L3 access authentication result to the mobile node.

3. The method of claim 1, wherein the mobility control server and the user profile server use user-data-request (UDR) and user-data-answer (UDA) messages, or profile-update-request and profile-update-answer messages in order to transfer and update mobility control related profile information of the mobile node.

4. The method of claim 1, wherein the searching for the host channel adaptor and transmitting of the authentication information to the searched host channel adaptor comprises:
updating a user profile from the mobility control server to the user profile server after performing the re-access authentication procedure; and
searching for a host channel adaptor adjacent to the mobile node and transmitting the authentication information to the network access server which includes the searched host channel adaptor by using the mobility control server after performing the re-access authentication procedure.

5. The method of claim 4, wherein in the searching for the host channel adaptor and transmitting the authentication information to the network access server, when a plurality of host channel adaptors are found according to a type of an L2 network interface card mounted in the mobile node, the authentication information is transmitted to all network access servers which includes the corresponding host channel adaptors.

6. A system for controlling access network authentication in the process of a handover, the system comprising:
a user profile server which performs access authentication of a mobile node when the mobile node initially accesses a first access network;
a mobility control server which searches for a host channel adaptor adjacent to the mobile node and transmits ID, profile and authentication information of the mobile node to a network access server which includes the searched host channel adaptor; and
a network access server which performs a handover of the mobile node when the mobile node moves to a second access network, receives authentication information of the mobile node, and performs re-access authentication,
wherein the mobile control server searches for a host channel adaptor adjacent to the mobile node and transmits the authentication information to a network access server which includes the searched host channel adaptor after the re-access authentication is performed.

7. The system of claim 6, wherein the network access server maintains the authentication information used for an initial access authentication of the mobile node during an L3 access procedure, and performs an L2 handover procedure and transfers L2 ID and authentication information to a network access server which belongs to the second access network when the mobile node moves to the second access network; and, when a handover is in progress, compares pieces of authentication information for each L2 ID which are transferred through the host channel adaptor and managed by the network access server in the second access network, determines whether to allow access, and transfers L3 access authentication result to the mobile node.

8. The system of claim 6, wherein the mobility control server and the user profile server use user-data-request (UDR) and user-data-answer (UDA) messages, or profile-update-request and profile-update-answer messages in order to transfer and update mobility control related profile information of the mobile node.

9. The system of claim 6, wherein the mobility control server updates a user profile to the user profile server after performing the re-access authentication procedure; and searches for the host channel adaptor adjacent to the mobile node and transmits the authentication information to the network access server which includes the searched host channel adaptor after performing the re-access authentication procedure.
